(19) United States
(12) Patent Application Publication
(10) Pub. No.: US 2022/0335085 A1
(43) Pub. Date: Oct. 20, 2022

(54) DATA SELECTION METHOD, DATA SELECTION APPARATUS AND PROGRAM

(71) Applicant: NIPPON TELEGRAPH AND TELEPHONE CORPORATION, Tokyo (JP)

(72) Inventors: Shunsuke TSUKATANI, Tokyo (JP); Kazuhiko MURASAKI, Tokyo (JP); Shingo ANDO, Tokyo (JP); Atsushi SAGATA, Tokyo (JP)

(73) Assignee: NIPPON TELEGRAPH AND TELEPHONE CORPORATION, Tokyo (JP)

(21) Appl. No.: 17/631,396

(22) PCT Filed: Jul. 30, 2019
(86) PCT No.: PCT/JP2019/029807

§ 371 Date: Jan. 28, 2022

(51) Int. Cl. G06F 16/906

(52) U.S. Cl. CPC G06F 16/906

(57) ABSTRACT

A data selection method selects, based on a set of labeled first data pieces and a set of unlabeled second data pieces, a target to be labeled from the set of the second data pieces. The method includes: a classification procedure classifying data pieces belonging to the set of the first data pieces and data pieces belonging to the set of the second data pieces into clusters of the number at least one more than the number of types of the labels; and a selection procedure selecting the second data piece to be labeled from a cluster, from among the clusters, that does not include the first data piece, each of the procedures being performed by a computer. Thereby, it is possible to select the data piece to be labeled, which is effective for a target task, from among data sets of unlabeled data pieces.

### TECHNICAL FIELD

The present invention relates to a data selection method, a data selection device and a program.

### BACKGROUND ART

In supervised learning, since labeled data pieces corresponding to a target task is required, there is a demand for reducing costs of the operation of labeling a large number of collected image data pieces. One of the technologies aimed at reducing the cost of the labeling operation is active learning, which performs efficient learning by selecting a small number of data pieces (samples) from the entire data pieces and labeling thereof, not labeling all the image data pieces.

In the active learning, samples with high contribution to performance improvement are selected (sampled) by an algorithm from unlabeled data pieces using a small number of labeled data pieces and presented to an operator. The operator labels the samples, then the learning is performed, and thereby learning performance can be improved as compared to the case of random sampling.

Since the number of samples is one per sampling in the conventional active learning, a technique for obtaining multiple samples in a single sampling, which is adapted to batch learning of convolutional neural networks (CNN) is suggested (Non-Patent Literature 1).

In Non-Patent Literature 1, the data pieces are mapped into the feature space, and sampling is performed by using an approximation solution algorithm for the k-center problem. Since multiple samples are subsets that inherit the characteristics of the entire data structure in the feature space, the learning close to that in using all data pieces can be performed even when a small number of data pieces are used.

### CITATION LIST

### Non-Patent Literature

Non-Patent Literature 1: Active Learning for Convolutional Neural Networks: A Core-Set Approach, O. Sener, S. Savarese, International Conference on Learning Representations (ICLR), 2018.
Non-Patent Literature 2: Mathilde Caron, Piotr Bojanowski, Armand Joulin, and Matthijs Douze, “Deep Clustering for Unsupervised Learning of Visual Features” Proc. ECCV (2018).

### SUMMARY OF THE INVENTION

### Technical Problem

However, the above technique has the following problems.

When data pieces are mapped into a feature space, it is necessary to prepare a feature extractor, and in many cases, a learned model prepared in a deep learning framework is used as the feature extractor. As the dataset used in the prepared learned model, the 1000-class classification of the ImageNet dataset, etc. is used.

Therefore, if classification of the data pieces for the target task differs from the classification contents of the dataset used in the prepared learned model, it is impossible to extract a feature that is effective for the target task.

In the technique of Non-Patent Literature 1, it is important for sampling to select a feature extractor performing mapping into a feature space that is effective for the target task, because the data is referenced in the feature space during sampling; however, it is difficult to evaluate beforehand the feature extractor that is effective for the unlabeled data pieces handled by the active learning.

The present invention has been made in view of the above points, and an object of the present invention is to make it possible to select data pieces to be labeled, which are effective for a target task, from among data sets of unlabeled data pieces.

### Means for Solving the Problem

To solve the above problems, a data selection method selects, based on a set of labeled first data pieces and a set of unlabeled second data pieces, a target to be labeled from the set of the second data pieces. The method includes: a classification procedure classifying data pieces belonging to the set of the first data pieces and data pieces belonging to the set of the second data pieces into clusters of the number at least one more than the number of types of the labels; and a selection procedure selecting the second data piece to be labeled from a cluster, from among the clusters, that does not include the first data piece, each of the procedures being performed by a computer.

### Effects of the Invention

It is possible to select data pieces to be labeled, which are effective for a target task, from among data sets of unlabeled data pieces.

### BRIEF DESCRIPTION OF DRAWINGS

FIG. 1 is a diagram showing an example of a hardware configuration of a data selection device 10 in a first embodiment.

FIG. 2 is a diagram showing an example of a functional configuration of the data selection device 10 in the first embodiment.

FIG. 3 is a flowchart for illustrating an example of processing procedures executed by the data selection device 10 in the first embodiment.

FIG. 4 is a diagram showing an example of a functional configuration of a data selection device 10 in a second embodiment.

### DESCRIPTION OF EMBODIMENTS

Hereinafter, embodiments of the present invention will be described based on the drawings.

In the embodiment, based on the input of data sets of labeled data pieces and data sets of unlabeled data pieces that are candidates for labeling, a feature extractor is generated by use of a framework of unsupervised feature expression learning. Note that the number of data pieces in the data set of the labeled data pieces is smaller than the number of data pieces in the data set of the unlabeled data pieces. The unsupervised feature expression learning is to generate a feature extractor effective for a target task by self-supervised learning, which uses supervisory signals that can be automatically generated for input data. The unsupervised feature expression learning includes techniques such as Deep Clustering (Non-Patent Literature 2).

For the feature of each labeled data piece and each unlabeled data piece used in the unsupervised feature expression learning, which is obtained by using the feature extractor obtained by the unsupervised feature expression learning, clustering is performed.

For each cluster obtained as a result of the clustering, classification is performed into two types of clusters: clusters including labeled data pieces and clusters including no labeled data pieces among the data pieces belonging thereto.

Of the two types of classification described above, sampling is performed from each cluster including no labeled data pieces, and the data pieces to be labeled are outputted.

Let us consider an unlabeled data piece that is effective for a target task, and should be labeled. For example, even if an unlabeled data piece having similar characteristics to a labeled data piece is labeled, it is difficult to say that the data piece is effective for the target task. On the other hand, if it is possible to label an unlabeled data piece having characteristics different from those of a labeled data piece, it is assumed that, by performing learning by using the data piece and the label, it becomes possible to learn so that identification taking into account the characteristics can be performed.

The embodiment aims to select such unlabeled data pieces having characteristics different from those of the labeled data pieces. It was described that the number of the unlabeled data pieces is larger than the number of the labeled data pieces, but it is expected that the number of the unlabeled data pieces will form a majority because labeling the data pieces for using thereof as actual learning data requires a large amount of operation. The embodiment aims to extract data pieces, from such a large number of data pieces, that should be labeled, and can increase, for example, the accuracy of estimation by labeling.

According to the above method, it is possible to use any feature expression learning technique, and it is possible to eliminate the need for preparation of the learned model.

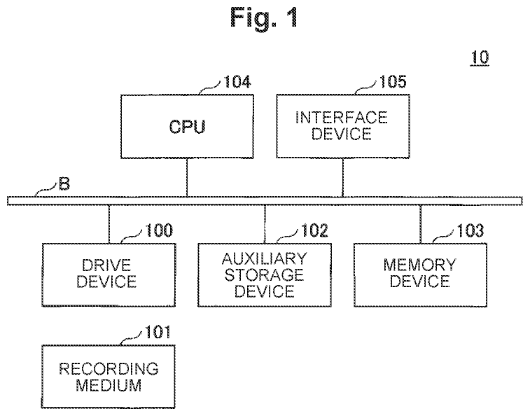

FIG. 1 is a diagram showing an example of a hardware configuration of a data selection device 10 in the first embodiment. The data selection device 10 in FIG. 1 includes a drive device 100, an auxiliary storage device 102, a memory device 103, a CPU 104, and an interface device 105 that are connected to one another via a bus B.

The programs implementing the processes in the data selection device 10 are provided by a recording medium 101, such as a CD-ROM. When the recording medium 101 storing the programs is set to the drive device 100, the programs are installed from the recording medium 101 to the auxiliary storage device 102 via the drive device 100. However, the programs are not necessarily be installed from the recording medium 101, and may be downloaded from other computers via a network. The auxiliary storage device 102 stores the installed programs, as well as necessary files, data, and the like.

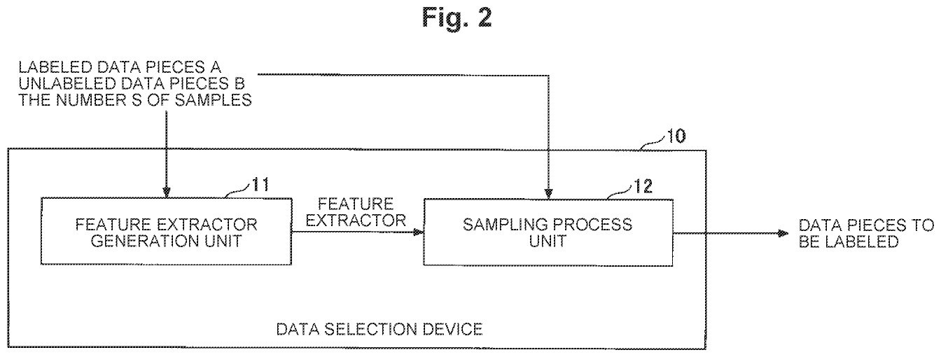

When an instruction to start the programs is provided, the memory device 103 reads the programs from the auxiliary storage device 102 and stores thereof. The CPU 104 executes the functions related to the data selection device 10 in accordance with the programs stored in the memory device 103. The interface device 105 is used as an interface to connect to the network. FIG. 2 is a diagram showing an example of a functional configuration of the data selection device 10 in the first embodiment. In FIG. 2, the data selection device 10 includes a feature extractor generation unit 11 and a sampling process unit 12. Each of these units is implemented by processes executed by the CPU 104 caused by one or more programs installed in the data selection device 10.

The feature extractor generation unit 11 outputs a feature extractor with a data set A of labeled data pieces, a data set B of unlabeled data pieces, and the number S of samples to be additionally labeled as input. The data set A of the labeled data pieces refers to a set of labeled image data pieces. The data set B of the unlabeled data pieces refers to a set of unlabeled image data pieces.

The sampling process unit 12 selects data pieces to be labeled with the data set A of the labeled data pieces, the data set B of the unlabeled data pieces, the number S of samples to be additionally labeled, and the feature extractor as input.

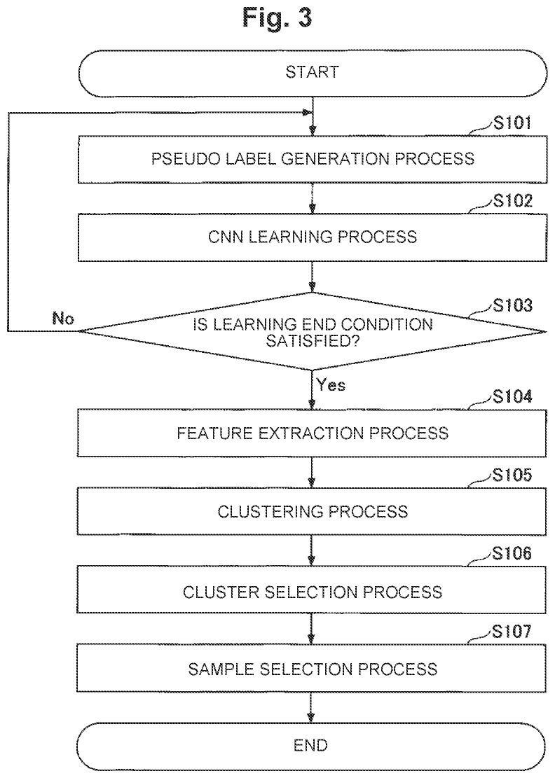

Hereinafter, the processing procedures executed by the data selection device 10 will be described. FIG. 3 is a flowchart for illustrating an example of processing procedures executed by the data selection device 10 in the first embodiment.

In step 101, the feature extractor generation unit 11 executes a pseudo label generation process with the data set A of the labeled data pieces, the data set B of the unlabeled data pieces, and the number S of samples to be additionally labeled as input. In the pseudo label generation process, the feature extractor generation unit 11 provides pseudo labels to each data piece aEA and each data piece b∈B, and outputs a data set A in which each data piece a is provided with a pseudo label and a data set B in which each data piece b is provided with a pseudo label as pseudo datasets. On this occasion, the feature extractor generation unit 11 performs k-means clustering on the data set A and the data set B, based on respective intermediate features of each data piece a and each data piece b when each data piece is inputted into Convolutional Neural Network (CNN), which is the source of the feature extractor, to thereby provide identification information corresponding to a cluster, to which each data piece belongs, to the data piece belonging to the cluster as a pseudo label. Note that the feature extractor generation unit 11 randomly initializes the first CNN parameter, and uses the sum of the number of data pieces in the data set A and S as the number of clusters in k-means clustering.

Subsequently, the feature extractor generation unit 11 performs a CNN learning process (S102). In the CNN learning process, the feature extractor generation unit 11 learns the CNN using the pseudo dataset as input. On this occasion, the learning using the pseudo data is also performed on the data piece a, which is labeled.

Steps S101 and S102 are repeated until a learning end condition is satisfied (S103). Whether or not the learning end condition has been satisfied may be determined, for example, by whether the number of repetitions in steps S101 and S102 has reached a predefined number of repetitions, or by the changes in the error function. When the learning end condition is satisfied, the feature extractor generation unit 11 regards the CNN at that time as the feature extractor and outputs thereof.

Thus, in steps S101 to S103, unsupervised feature expression learning is used to generate (learn) the feature extractor. However, the method of generating the pseudo labels is not limited to the method as described above.

Subsequently, the sampling process unit 12 performs a feature extraction process (S104). In the feature extraction process, the sampling process unit 12 uses the feature extractor to obtain (extract) respective feature information (image feature) of each data piece a in the data set A and each data piece b in the data set B. In other words, the sampling process unit 12 inputs each data piece a in the data set A and each data piece b in the data set B into the feature extractor in turn, to thereby obtain the feature information, which is outputted from the feature extractor, for each data piece a and each data piece b. Note that the feature information is data expressed in a vector form.

Subsequently, the sampling process unit 12 performs a clustering process (S105). In the clustering process, with the feature information of each data piece a, the feature information of each data piece b, and the number S of samples to be additionally labeled as input, the sampling process unit 12 performs k-means clustering on a feature information group, and outputs cluster information (information including the feature information of each data piece and the results of classification of each data piece into a cluster). On this occasion, the sum of the number of data pieces in the data set A and the number S of the samples is regarded as the number of clusters of k-means. In other words, each data piece a and each data piece b are classified into the clusters of the number at least one more than the number of data pieces in the data set A.

Subsequently, the sampling process unit 12 performs a cluster selection process (3106). In the cluster selection process, with the data set A, the data set B, and the cluster information as input, the sampling process unit 12 outputs S clusters for sample selection.

The clusters generated by k-means clustering in the clustering process of step 3105 are classified into the cluster including the data pieces aEA and the data pieces b∈B, and the cluster including only the data pieces b.

Since the cluster including the data pieces a is considered to be a set of data pieces that can be identified by learning using the data pieces a, it is considered that selection of a data piece b included in the cluster as a sample will result in a low learning effect.

On the other hand, the cluster including only the data pieces b without including the data pieces a is considered to include the data pieces that are difficult to identify by learning using the data pieces a; therefore, the data piece b included in the cluster is considered to have high learning effectiveness as a sample.

Thus, one sample is to be selected from each cluster including only the data pieces b (that is, each cluster that does not include the data pieces a); however, since the number of clusters including only the data pieces b is not less than S, the sampling process unit 12 selects the cluster to be sampled in step S105.

Specifically, in the feature information {xᵢ}ⁿᵢ₌₁ and the cluster level {y|y∈{1, . . . , k)}}ⁿᵢ₌₁, when the center of the cluster y (the center of the feature information group of each data piece belonging to the cluster y) is assumed to be u_{y}=1/n_{y}Σ_{i:yi=y}xᵢ (n_{y} is the number of data pieces belonging to the cluster y), the sampling process unit 12 calculates a score value t in the cluster by the following expression:

$$t = \frac{1}{{n}_{y}} {\sum }_{i : {y}_{i} = y} {‖ {x}_{i} - {u}_{y} ‖}^{2} \qquad [ Math . 1 ]$$

The sampling process unit 12 selects S clusters as the clusters for sample selection, starting with a cluster having a relatively small score value t in the ascending order. Since the score value t is a variance, a cluster having a low score value t is the cluster with a small variance. It is assumed that, as described above, the group of data pieces b belonging to such a cluster with a small variance is a set of data pieces that does not exist in the labeled data group or have features that are only expressed small. Therefore, the data pieces b selected from such a cluster are considered to be highly influential.

Subsequently, the sampling process unit 12 performs a sample selection process (S107). In the sample selection process, the sampling process unit 12 performs sampling on each of the S clusters for sample selection. For example, for each cluster for sample selection, the sampling process unit 12 selects the data piece b related to the feature information with the minimum distance from the center u_{y} of the cluster (the distance between vectors) as the sample. The data piece at the center of the cluster is considered to be the data piece that most strongly expresses the common feature of the cluster. In addition, noise reduction can also be expected because the data piece can also be regarded as the average of the data pieces belonging to the cluster. The sampling process unit 12 outputs each sample (each data piece b) selected from each of the S clusters as the data piece to be labeled.

As described above, according to the first embodiment, the feature information of each data piece is obtained (extracted) by use of the feature extractor that has provided the pseudo label, which can be automatically generated only from the data set A of the labeled data pieces and the data set B of the unlabeled data pieces, to each data piece and has learned; therefore, the sampling based on the feature space effective for the target task is performed, and as a result, it is possible to select the data piece, that is to be labeled and is effective for the target task, from among data sets of unlabeled data pieces.

In addition, since it becomes possible to perform sampling on the feature space without preparing a learned model beforehand, it is possible to eliminate the selection of a feature extractor adapted to a target task for given image data, and to reduce the cost of labeling since high learning performance can be obtained by providing labels to a small number of samples.

Moreover, in the embodiment, a cluster including only the unlabeled data pieces is selected in sampling, and the technique for selecting the data piece closest to the center of the cluster is applied. Therefore, in the embodiment, it becomes possible to select data pieces in a range that cannot be covered by the labeled data pieces on the feature space; thereby it becomes possible to reduce the cost of efficient labeling operations.

Next, a second embodiment will be described. In the second embodiment, description will be given to the points that are different from the first embodiment. Points not specifically mentioned in the second embodiment may be similar to those of the first embodiment.

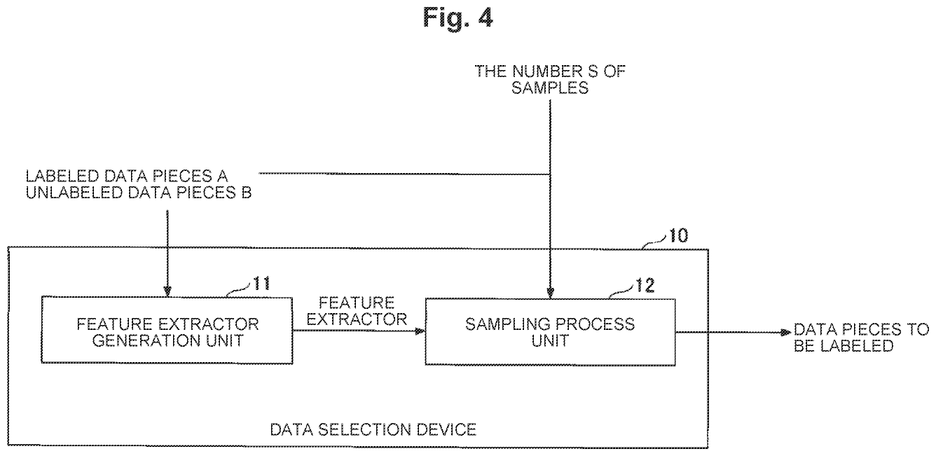

FIG. 4 is a diagram showing an example of a functional configuration of a data selection device 10 in the second embodiment. In the second embodiment, a generation method of the pseudo label by the feature extractor generation unit 11 is different from the first embodiment. Due to the differences in the generation method, in the second embodiment, input of the number S of samples to be additionally labeled to the feature extractor generation unit 11 may not be required.

For example, in the case where the image of each data piece to be inputted (each data piece a and each data piece b) is randomly rotated, the feature extractor generation unit 11 may use the rotation direction of the image of each data piece as a pseudo label for each data piece. Alternatively, in the case where the image of each data piece (each data piece a and each data piece b) is divided into patches and randomly inputted, the feature extractor generation unit 11 may use the correct permutations of the patches of each data piece as a pseudo label for each data piece. Still alternatively, the feature extractor generation unit 11 may generate the pseudo label for each data piece by other known methods.

Note that, in each of the above embodiments, the feature extractor generation unit 11 is an example of a generation unit. The sampling process unit 12 is an example of an obtaining unit, a classification unit, and a selection unit. The data piece a is an example of a first data piece. The data piece b is an example of a second data piece.

The embodiments of the present invention have been described, but it is not intended to limit the present invention to these specific embodiments. Various kinds of modifications and variations can be made within the scope of the gist of the present invention defined by the following claims.

### REFERENCE SIGNS LIST

10 Data selection device
11 Feature extractor generation unit
12 Sampling process unit
100 Drive device
101 Recording medium
102 Auxiliary storage device
103 Memory device
104 CPU
105 Interface device
B Bus

1. A computer-implemented method for selecting target data for labeling using a set of labeled first data pieces and a set of unlabeled second data pieces, the method comprising:
classifying data pieces belonging to the set of the first data pieces and data pieces belonging to the set of the second data pieces into a number of clusters, the number of clusters being at least one more than the number of types of the labels; and
selecting a data piece from the set of the second data pieces to be labeled from a cluster, from among the clusters, that does not include one of the first data pieces.

2. The computer-implemented method according to claim 1, the method further comprising:
generating a feature extractor by using unsupervised feature expression learning based on the set of the first data pieces and the set of the second data pieces; and
obtaining feature information for each of the first data pieces and each of the second data pieces by using the feature extractor, wherein
the classifying classifies the set of the first data pieces and the set of the second data pieces into the clusters based on the feature information.

3. The computer-implemented method according to claim 2, wherein the selecting selects the data piece from the set of the second data pieces to be labeled from a cluster having a relatively small variance of the feature information.

4. The computer-implemented method according to claim 2, wherein the selecting selects, in the cluster that does not include the first data pieces, the data piece from the set of the second data pieces related to the feature information with a minimum distance from a center of the cluster.

5. A data selection device comprising a processor configured to execute a method for selecting, based on a set of labeled first data pieces and a set of unlabeled second data pieces, a target to be labeled from the set of the second data pieces, comprising:
classifying data pieces belonging to the set of the first data pieces and data pieces belonging to the set of the second data pieces into a number of clusters, the number clusters being at least one more than the number of types of the labels; and
selecting a data piece from the set of the second data pieces to be labeled from a cluster, from among the clusters, that does not include one of the first data pieces.

6. The data selection device according to claim 5, the processor further configured to execute a method comprising:
generating a feature extractor by using unsupervised feature expression learning based on the set of the first data pieces and the set of the second data pieces; and
obtaining feature information for each of the first data pieces and each of the second data pieces by using the feature extractor, wherein
the classifying classifies the set of the first data pieces and the set of the second data pieces into the clusters based on the feature information.

7. The data selection device according to claim 6, wherein the selecting selects the data piece from the set of the second data pieces to be labeled from a cluster having a relatively small variance of the feature information.

8. A computer-readable non-transitory recording medium storing computer-executable program instructions that when executed by a processor cause a computer system to execute a data selection method comprising:
classifying data pieces belonging to a set of labeled first data pieces and data pieces belonging to a set of unlabeled second pieces into a number of clusters, the number of clusters being at least one more than a number of types of labels; and
selecting a data piece from the set of the second data pieces to be labeled from a cluster, from among the clusters, that does not include one of the first data pieces.

9. The computer-implemented method according to claim 2, wherein the classifying uses a convolutional neural network.

10. The computer-implemented method according to claim 2, wherein the obtaining feature information is based on k-means clustering on the set of the first data pieces and the set of the second data pieces.

11. The computer-implemented method according to claim 3, wherein the selecting selects, in the cluster that does not include the first data pieces, the data piece from the set of the second data pieces related to the feature information with a minimum distance from a center of the cluster.

12. The computer-readable non-transitory recording medium according to claim 8, the computer-executable program instructions when executed further causing the computer system to execute a data selection method comprising:
generating a feature extractor by using unsupervised feature expression learning based on the set of the first data pieces and the set of the second data pieces; and
obtaining feature information for each of the first data pieces and each of the second data pieces by using the feature extractor, wherein
the classifying classifies the set of the first data pieces and the set of the second data pieces into the clusters based on the feature information.

13. The data selection device according to claim 6, wherein the selecting selects the data piece from the set of the second data pieces to be labeled from a cluster having a relatively small variance of the feature information.

14. The data selection device according to claim 6, wherein the selecting selects, in the cluster that does not include the first data pieces, the data piece from the set of the second data pieces related to the feature information with a minimum distance from a center of the cluster.

15. The data selection device according to claim 6, wherein the classifying uses a convolutional neural network.

16. The data selection device according to claim 6, wherein the obtaining feature information is based on k-means clustering on the set of the first data pieces and the set of the second data pieces.

17. The computer-readable non-transitory recording medium according to claim 12, wherein the selecting selects the data piece from the set of the second data pieces to be labeled from a cluster having a relatively small variance of the feature information.

18. The computer-readable non-transitory recording medium according to claim 12, wherein the selecting selects, in the cluster that does not include the first data pieces, the data piece from the set of the second data pieces related to the feature information with a minimum distance from a center of the cluster.

19. The computer-readable non-transitory recording medium according to claim 12, wherein the classifying uses a convolutional neural network.

20. The computer-readable non-transitory recording medium according to claim 12, wherein the obtaining feature information is based on k-means clustering on the set of the first data pieces and the set of the second data pieces.
